(19) United States
(12) Patent Application Publication
(10) Pub. No.: US 2026/0220127 A1
(43) Pub. Date: Jul. 30, 2026

(54) METHOD FOR GENERATING A REQUEST

(71) Applicant: IUI LIFE, Paris (FR)

(72) Inventors: Ghassan Baghdadi, Ivry-sur-Seine (FR); Ann Christine Tan, Ivry-sur-Seine (FR); Gretl Baghdadi

(21) Appl. No.: 19/141,720

(22) PCT Filed: Dec. 22, 2023
(86) PCT No.: PCT/EP2023/087771

§ 371 Date: Jun. 20, 2025

(30) Foreign Application Priority Data
Dec. 23, 2022 (FR) 2214467

(51) Int. Cl. G06F 16/242

(52) U.S. Cl. CPC G06F 16/2428

(57) ABSTRACT

The invention relates to a computer-implemented method for generating a query, said method comprising:
A first displaying (AFF₁) on a display, by means of the calculator, of a plurality of lists of first objects, each list of first objects being positioned on a first line on the display;
A first actuation (ACT₁) of a first actuated object taken from the first objects arranged on a first line by means of a first user command;
Automatically updating (MAJ₁), by the calculator, of the first objects in at least one list,
Generation (GEN_{req}), by means of a second user command, of the query, said query comprising query parameters associated with the first actuated object.

### PRIORITY

This application is the national stage entry of International Application No. PCT/EP2023/087771, filed on Dec. 22, 2023, which claims priority to France Patent Application No. 2214467, filed on Dec. 23, 2022, under 35 U.S.C. § 119 or 120, the contents of which are incorporated herein by reference in their entirety.

### TECHNICAL FIELD

The field of the inventive concepts relates to the field of computer-implemented methods for generating queries, such as search queries.

More particularly, the field of the inventive concepts relates to the field of computer-implemented methods for generating complex queries, such as queries to be submitted to a search engine, to an artificial intelligence, e.g. generative, to a computer operating system, or to other software applications, e.g. a “super-app” from parameters associated with objects selected from lists.

In particular, the field of the inventive concepts relates to the field of computer-implemented methods for generating complex queries while allowing easy and instinctive navigation by a user through a large amount of data organized according to a logical scheme.

### BACKGROUND

Access to knowledge has always been fundamental for human beings. Nowadays, rapid developments in technology has made access to information easier for the greatest number of people. The performance and optimization of means enabling this access to information has become a major challenge for our societies. With the advent of the Internet, information has become more accessible to everyone through queries submitted to search engines or generative artificial intelligence (GenAI) algorithms.

Beyond access to knowledge, it is also possible to carry out a large number of actions via search engines, software applications or digital portals that have a direct impact on real life, such as various bookings (travel, restaurants, cinema, various learning courses, etc.). It has therefore become essential to provide users with intuitive interfaces to guide them through their searches and give them rapid access to the most relevant results based on the information they are seeking.

Today, smartphones are widely used by the majority of the population. Users face various constraints when using these devices, one of which is the limited size of the display.

Today's digital portals, such as corporate websites and applications, as well as the personal digital devices used to access digital portals, contain a vast and ever-increasing amount of content that can only be viewed on a finite screen size.

As digital portal producers compete for customer adoption, engagement and loyalty, they are forced to offer ever more content, recommendations and “click traps”, and try to present this content in the best possible way to enrich the user experience. With so much content to navigate on a small screen, consumers end up being limited rather than guided or assisted in the technical task of generating a query: they receive too many results when they perform a search, they have to scroll through several pages to find the relevant elements to generate their query, they are often led into “rabbit holes”, which distract them and make them lose concentration, and they have to toggle to open different applications and re-enter data to accomplish tasks, which slows them down in getting a relevant result. The result is a vicious producer-consumer cycle that only gets worse over time.

Users are also limited when browsing on their own digital devices (such as personal computers and smartphones), where, in addition to the vast content accessible from other producers (via installed applications, web browsers and application stores), users also produce their own content (files, photos, e-mails, messages, etc.). The operating systems of these devices add tools such as tags or labels—in addition to their search functions—to help users navigate and find their files. However, users sometimes store a significant amount of content, making it difficult to find a particular file without using a search function, even when the users themselves have chosen where to store that file on their device in the first place.

In this paradigm, the producers of digital portals know which links users are more likely to click on, but they don't get much out of it, except by producing more of these links. It is difficult for them to understand what action to take as a result of these clicks, because they don't know exactly why each user decided to click on a given link.

Whether using digital devices to access one's own content, or portals for other people's content, there is a disconnect between producers and users. It is therefore essential to provide a new producer-user paradigm, simultaneously giving producers'digital portals a competitive edge beyond incremental efficiency, while empowering users of these portals. Thus, users adopt, engage with, and return to these producers'digital portals again and again because they are not restricted to them and can find and do what they want easily and efficiently, and producers focus on producing what users are looking for without having to guess or use “click traps” because they can present their content logically and have the business intelligence from the inherently multidimensional learnings of users interacting with their content.

Such business intelligence advantageously informs producers of exactly what users are looking for when they visit their portal, enabling producers to serve them better, even on a personalized individual basis, thus reversing the vicious circle of prior art devices into a virtuous circle.

A drawback of existing solutions is that they only take into account a limited number of parameters for defining queries, which are notably extrinsic characteristics relating to the user: for example, when searching for an event, or when browsing or exploring to find an event, these parameters may relate to the event searched for, the location of the event, its date and its duration.

Thus, in the prior art, characteristics intrinsic to the user are not taken into account. These intrinsic characteristics include, for example, the user's profile, centers of interest, and goals related to these centers of interest.

Another drawback of prior art solutions is that they do not allow defining search queries that accurately reflect what the user is looking for. As a result, the results of such a search generally include too many results, some of which are not relevant to the user, adding unnecessary cognitive load to the user.

Another drawback of prior art solutions is that the user cannot optimally access a specific piece of information or a specific result he is looking for without having to navigate through many different pages, many different links or many different folders, which again adds an unnecessary cognitive load to the user.

Another disadvantage of prior art solutions is that they suggest unsuitable recommendations to the user, wasting time and distracting them from the primary objective of his search.

Another drawback of the prior art is that it is necessary to switch between several applications or web pages to perform a complex multi-criteria query or search (e.g. for a complex multi-criteria transaction including the booking of a trip which includes the booking of a hotel, several train tickets and a plane ticket, with user data having to be entered several times for the booking of each service).

Another drawback of prior art solutions is that they rely on knowledge of the user at a given moment, a memory or even their imagination, which limits the query input parameters, and consequently the results obtained.

Another disadvantage is that the entire content of a portal has to be loaded each time it is accessed, requiring a significant amount of data transfer bandwidth from the server. This puts users with slow Internet connections at a major disadvantage, as well as those who can only afford small data packages or have older, slower devices.

The inventive concepts aims to limit the aforementioned disadvantages.

### SUMMARY

According to a first aspect, the inventive concepts relates to a computer-implemented method for generating a search query by means of a system comprising a display and a calculator, said method comprising: a first displaying on the display controlled by the calculator, of a plurality of lists of first objects, the first objects of each list of first objects being positioned on a first line of the display, the first objects of the respective lists being positioned on different respective first lines; a first actuation of at least one first actuated object from a list of the plurality of lists by a first user command; a first automatic update, by the calculator and in response to the first user command, of the first objects of at least one list taken from the plurality of lists and distinct from the list to which the first actuated object belongs, said automatic update resulting in the display of at least one new first object on the first line on which are displayed the first objects of said list distinct from the list to which the first actuated object belongs, a generation, by the calculator in response to a second user command, of the search query, said search query comprising query parameters associated with said first actuated object.

According to another example embodiment, the method comprises: a second actuation, by a third user command, of at least one second actuated object taken from among the first objects of a list of the plurality of lists distinct from the list to which the first actuated object belongs, said second actuation causing the calculator to extract values from digital entities stored in a memory, said digital entities each being associated with the second actuated object; and a second displaying, on the display and controlled by the calculator in response to the third user command, of a sub-list of first objects on a second line coincident with, parallel to, or concentric with the first line on which is displayed the list to which the actuated first object belongs, the query parameters comprising the values of digital entities associated with the actuated second object.

According to another example embodiment, the method comprises: a first positioning, by a fourth user command, of a first object to be positioned taken from among the first objects of one of the lists or of the sub-list at an intersection between the first line on which the first object to be positioned is displayed and a reference line of the screen, the query parameters being associated with each first object displayed at the intersection of one of the lines and the reference line.

According to another example embodiment, the method comprises a step of second positioning, by the fourth user command, of at least one second object to be positioned taken from among the first objects of a list of the plurality of lists distinct from that on which the first object to be positioned is displayed, at an intersection between the first line on which said second object to be positioned is displayed and the reference line.

In an embodiment, at least two of the first lines are non-intersecting.

In an embodiment, at least two of the first lines are parallel.

In an embodiment, the reference line is perpendicular to at least two first lines and centered on the display.

In an embodiment, at least one of the first lines is a first circle.

According to another example embodiment, the reference line passes through a center of the first circle and the method comprises: a third positioning, by the fourth user command, of at least a third object to be positioned, taken from the first objects displayed on the first circle, inside a second circle concentric with the first circle and with a radius smaller than the length of the radius of the first circle; a second automatic update, by the calculator, of the list of first objects positioned on the first circle in response to the third positioning, said update resulting in the display of at least one new first object on the first circle, the search query being generated from query parameters associated with the third object to be positioned.

In an embodiment, the first lines are concentric circles, and wherein the reference line comprises at least one radius of the circle of greatest diameter taken from the concentric circles.

In an embodiment, the display is a touch screen.

According to an embodiment, the method comprises an automatic update, from an application programming interface comprising at least one software application, of the first objects of at least one of the first lists or of the one sub-list.

In another example embodiment, the query parameters comprise parameterized or predetermined user profile parameters.

According to an embodiment, the method comprises: a fourth displaying, controlled by the calculator, of a list of second objects on a third line; a third actuation of at least one third actuated object selected from the second objects by means of the first user command; a third automatic update, by the calculator, of all the lists of first objects, said update resulting in the display of new first objects on the first lines.

According to one embodiment, the method comprises: third display on the display, controlled by the calculator, of at least a third object associated with digital entity values stored in a memory, said digital entity values comprising timestamp parameters, the query parameters comprising the timestamp parameters of said digital entity values associated with the third object.

In one embodiment, the first command and the second command are identical. According to another aspect, the inventive concepts relates to a system for generating a search request comprising software and/or hardware means configured to implement the steps of the process according to the inventive concepts.

According to an embodiment, the software and/or hardware means comprise a display, a memory and a calculator, the system being configured to: Display, on the display by a command from the calculator, a plurality of lists of first objects, the first objects of each list of first objects being positioned on a first line of the display, the first objects of the respective lists being positioned on different respective first lines; Automatically update, by means of the calculator and in response to a first user command, of the first objects of at least one list taken from the plurality of lists and distinct from the list to which the first actuated object belongs, said automatic updating resulting in the display of at least one new first object on the first line on which are displayed the first objects of said list distinct from the list to which the first actuated object belongs, and Generate the search query, by means of the calculator and in response to a second user command, said search query comprising query parameters associated with said first actuated object.

In an embodiment, the memory comprises data processed in real time by at least one learning function.

According to another aspect, the inventive concepts relates to a computer program product comprising instructions which, when the program is executed by a calculator, causes the system according to the inventive concepts to implement the steps of the process of the inventive concepts.

According to another aspect, the inventive concepts relates to a computer-implemented method for generating a query by means of a system comprising a display and a calculator, said method comprising: A first calculator controlled displaying of a plurality of lists of a plurality of first objects, the first objects of each list of first objects being positioned simultaneously on a first line of the display and each being operable by means of at least one first user command, each plurality of first objects of the respective lists being positioned on different respective first lines; A first actuation of at least one first actuated object from a list of the plurality of lists by the first user command; A first automatic update, by the calculator and in response to the first actuation, of the first objects of at least one list taken from the plurality of lists and distinct from the list to which the first actuated object belongs, said automatic update resulting in the display of at least one new first object on the first line on which are displayed the first objects of said list distinct from the list to which the first actuated object belongs, and A generation, by the calculator in response to a second user command, of the request comprising request parameters associated with said first object actuated by the first actuation.

According to an embodiment, the query is a software query selected from a search query to be submitted to a search engine, a generation query to be submitted to a generative artificial intelligence algorithm, a query to be submitted to a software application or a query to be submitted to an operating system.

According to an embodiment, the process further comprises a step of displaying a list of second objects characterizing categories of user profiles positioned simultaneously on the same line distinct from the first line, said second objects each being independently actuatable by means of a user command, said actuation resulting in automatic updating by the calculator of at least one first object of at least one list taken from the plurality of lists.

According to an embodiment, at least one first object of at least one list from the plurality of lists is operable by means of a user command to display a sub-list of Boolean operators displayed simultaneously with said first objects on the display and on a separate line, said Boolean operators being operable to combine and/or exclude query parameters associated with at least two selected first objects.

According to an embodiment, actuation of a first object by means of a user command results in extraction of data associated with said first actuated object, the calculator being configured to process said extracted data to simultaneously update the set of lists displayed on the display, said updated lists being simultaneously displayed on the display.

According to an example embodiment, the method comprises: A second actuation, by a third user command, of at least one second actuated object taken from among the first objects of a list of the plurality of lists distinct from the list to which the first actuated object belongs, said second actuation causing the calculator to extract values from digital entities stored in a memory, said digital entities each being associated with the second actuated object; and A second displaying, on the display and controlled by the calculator in response to the third user command, of a sub-list of first objects on a second line coincident with, parallel to, or concentric with the first line on which is displayed the list to which the actuated first object belongs, the query parameters comprising the values of digital entities associated with the actuated second object.

According to an embodiment, the method comprises a step of a first positioning, by a fourth user command, of a first object to be positioned taken from among the first objects of one of the lists or of the sub-list at an intersection between the first line on which the first object to be positioned is displayed and a reference line of the screen, the query parameters being associated with each first object displayed at the intersection of one of the lines and the reference line, said first positioning resulting in an automatic update of all the lists of the plurality of lists.

According to an embodiment, the process further comprises a step of automatically encoding the lists of first objects, said encoding being implemented by the calculator using user preference data, each encoded list symbolizing a category of query parameters distinct from the other encoded lists.

According to an embodiment, the encoding step further comprises implementing a learning function to dynamically update each list of first objects in real time.

According to an embodiment, the encoding step further comprises implementing a learning function to dynamically update each list of first objects in real time.

In an embodiment, automatic encoding of the lists of first objects automatically results in said lists being displayed together on the same page of the display.

In an embodiment, at least one first object, second object, third object, fourth object or fifth object from an object list is hidden in response to the actuation of at least one first object, second object, third object, fourth object or fifth object from said object list or from a separate object list.

In an embodiment, at least one object list from the first object list, second object list, third object list, fourth object list and fifth object list is hidden in response to the actuation of at least one first object, second object, third object, fourth object or fifth object from said object list or from a separate object list.

In an embodiment, an update to at least one first object, second object, third object, fourth object or fifth object in an object list automatically updates at least one first object, second object, third object, fourth object or fifth object separate from said updated object.

In an embodiment, at least one of the first lines is a first circle.

According to an embodiment, the reference line passes through a center of the first circle, the method comprising: A third positioning, by the fourth user command, of at least a third object to be positioned, taken from the first objects displayed on the first circle, inside a second circle concentric with the first circle and with a radius smaller than the length of the radius of the first circle; A second automatic update, by the calculator, of the list of first objects positioned on the first circle in response to the third positioning, said update resulting in the display of at least one new first object on the first circle, the request

being generated from request parameters associated with the third object to be positioned.

According to an embodiment, the method comprises: A fourth displaying, controlled by the calculator, of a list of second objects on a third line; A third actuation of at least one third actuated object selected from the second objects by means of the first user command; A third automatic update, by the calculator, of all the lists of first objects, said update resulting in the display of new first objects on the first lines.

According to an embodiment, the method comprises a step of a third displaying on the display, controlled by the calculator, of at least one third object associated with digital entity values stored in a memory, said digital entity values comprising timestamp parameters, the query parameters comprising the timestamp parameters of said digital entity values associated with the third object.

According to an embodiment, the first command comprises the second user command and/or comprises the third user command and/or comprises the fourth user command.

According to an embodiment, the method comprises a step of displaying a plurality of fourth objects symbolizing widgets that can be operated by a user and displayed simultaneously with the plurality of lists of first objects.

According to an embodiment, the method comprises a step of displaying a plurality of fifth objects displayed simultaneously with the plurality of lists of first objects and capable of receiving a plurality of data extracted in response to the actuation of a first object and/or a second object and/or a third object and/or a fourth object.

According to another aspect, the inventive concepts concerns a query generation system comprising software and/or hardware means configured to implement the steps of the process.

According to an example embodiment, the software and/or hardware means comprise a display, a memory and a calculator, said system being configured to: Display, on the display by a command from the calculator, a plurality of lists of first objects, the first objects of each list of first objects being positioned on a first line of the display, the first objects of the respective lists being positioned on different respective first lines; Automatically update, by means of the calculator and in response to a first user command, of the first objects of at least one list taken from the plurality of lists and distinct from the list to which the first actuated object belongs, said automatic updating resulting in the display of at least one new first object on the first line on which are displayed the first objects of said list distinct from the list to which the first actuated object belongs, and Generate the query by means of the calculator and in response to a second user command, said query comprising query parameters associated with said first actuated object.

In an embodiment, the memory comprises data processed in real time by at least one learning function.

According to another aspect, the inventive concepts relates to a computer program product comprising instructions which, when the program is executed by a calculator, cause the system to implement the process steps.

According to another aspect, the inventive concepts concerns a non-transitory calculator-readable recording medium on which the computer program product is recorded. By “non-transitory medium” is meant that the medium is a tangible medium. In other words, it is not a transient signal per se.

### BRIEF DESCRIPTION OF THE FIGURES

Further features and advantages of the inventive concepts will become apparent from the following detailed description, with reference to the appended figures which illustrate:

FIG. 1: A block diagram illustrating the process for generating a query, such as a search query or a query to be submitted to a generative artificial intelligence, an operating system or a software application.

FIG. 2: A block diagram of the process shown in FIG. 1, illustrating an embodiment in which it comprises a second actuation step and a second display step.

FIG. 3: A block diagram of the process shown in FIG. 1, illustrating an embodiment in which it comprises a step for positioning a first object in a list.

FIG. 4: A block diagram of the process shown in FIG. 1, illustrating an embodiment in which the step of positioning a first object of a list, and a step of positioning a first object of another list.

FIG. 5: A block diagram of the process shown in FIG. 1, illustrating an embodiment in which it comprises a step of displaying a third object associated with digital entity values comprising timestamp parameters.

FIG. 6: A block diagram of the process shown in FIG. 1, illustrating an embodiment in which it comprises a step of displaying a list of second objects, a step of actuating one of the second objects and a step of updating the set of lists of first objects.

FIG. 7: An illustration of a display after a calculator has carried out the steps of displaying a plurality of lists of first objects, a list of second objects and a third object.

FIG. 8:

FIG. 8A: An illustration of the implementation of the first user command.

FIG. 8B: An illustration of the implementation of the second user command.

FIG. 8C: An illustration of the implementation of the third user command.

FIG. 8D: An illustration of the implementation of the fourth user command.

FIG. 9: An illustration of the implementation of a step for automatic updating, by the calculator, of a plurality of lists of first objects in response to the implementation of the first user command on a first object.

FIG. 10: An illustration of the display after a step of displaying a plurality of lists of first objects, in an embodiment in which a list of first objects is positioned on a circle.

FIG. 11: An illustration of the implementation, by the calculator, of a step for automatically updating a list of first objects in response to the actuation of a first object by means of the fourth user command.

FIG. 12: An illustration of the implementation of an automatic update step, by the calculator, of the set of first object lists in response to the implementation of the first user command on a second object.

FIG. 13: A diagram of a hardware configuration configured to implement, in interaction with a user, the steps of the process of the inventive concepts.

### DETAILED DESCRIPTION

The present disclosure can be understood more readily by reference to the instant detailed description, examples, and claims. The present disclosure is not limited to the example embodiments and/or methods disclosed herein, which may, of course, vary. It is also to be understood that the terminology used herein is for the purpose of describing particular embodiments only and is not intended to be limiting. Unless defined otherwise, all technical and scientific terms used herein have the same meaning as commonly understood by one of ordinary skill in the art.

According to a first aspect, the inventive concepts concerns a computer-implemented method for generating a query. The inventive concepts advantageously enables a user to generate a complex multi-criteria query thanks to optimized data organization and easier navigation through the data. In the context of the inventive concepts, data can come from a variety of sources, such as websites or databases. Further examples will be given in the present description. The inventive concepts is applicable in a variety of cases, such as generating a query for educational or entertainment purposes, or for the purpose of purchasing goods, or services such as booking a trip or booking a medical appointment with a specialist. The inventive concepts is also applicable in the context of generating a query from personal data, for example time-stamped data (contacts, various files) and stored in a memory of a device (e.g. a smartphone, tablet or computer).

Advantageously, the inventive concepts makes it possible to assist a user in the technical task of generating a request, for example an encoding request for a digital portal. Such an encoding request results, for example, in the generation of a graphical interface comprising a plurality of modalities, such as visual modalities via the display of objects or haptic modalities via the activation of these objects by means of user commands. Such a graphical interface takes the form, for example, of a “digital portal” with whose content a user can interact effectively, notably by means of user commands, and in such a way that the interface can in turn “respond” dynamically to the user's interactions.

The inventive concepts is further adapted for different categories, e.g. market, media, personal, blog, etc., but an analysis of their content terms and/or an analysis of empirical data associated with similar or identical portals can provide an estimate of the purpose of a specific portal. For example, digital products and/or service market portals may be more likely to include products and prices (shopping/e-commerce) and/or to include services and schedules (booking), media portals may be more likely to include headlines and articles, and personal portals may be more likely to include files and multimedia elements.

In the remainder of the description, “by means of” has an equivalent meaning to “using”. Thus, when in an embodiment it is described that a query is generated “by means of” query parameters, this means that the query is generated using the query parameters. When, in another embodiment, it is described that a list or sub-list is updated “by means of” data stored in a memory, this means that the list or sub-list is updated using the data stored in the memory.

In the remainder of the description, “query” is taken to mean a software query, such as a search query that can be submitted to a search engine, but also a query to be submitted to an artificial intelligence algorithm, such as a generative artificial intelligence algorithm (GenAl), e.g. an artificial intelligence algorithm for generating an image, a query to be submitted to a computer operating system, or to any other type of software application (e.g. a “super app”). Thus, the inventive concepts is not limited to queries to be submitted to a search engine but relates to a process for generating any type of query that can be submitted to any type of software, via any type of interface.

In the present description, reference is made to lines on which lists of objects are arranged. In some embodiments, the lines are represented horizontally. However, the inventive concepts is not limited to this particular case. According to various embodiments, the lines are vertical lines on the screen, lines forming an angle of between 90° and −90 ° with a horizontal or vertical line on the screen, or any other angle. According to other embodiments, the inventive concepts may also comprise a simultaneous implementation of a combination of the above examples.

### First Objects

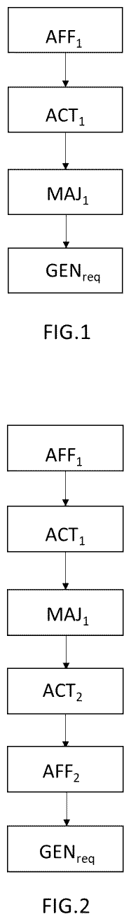

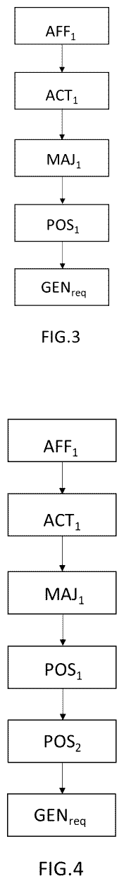

With reference to FIGS. 1 to 6, the method comprises a first step of displaying AFF₁ a plurality of lists L₁, . . . , Lₓ of first objects A₁, . . . , Aₓ.

The lists L₁, . . . , Lₓ of first objects A₁, . . . , Aₓ are displayed on a display E₁ by means of a calculator CLC₁.

The first objects A₁, . . . , Aₓ comprise, for example, graphical elements such as icons or pictograms. The first objects A₁, . . . , Aₓ are, for example, graphical representations of elements relating to a given category. Examples of categories are, but are not limited to: learning, health, mobility/transportation, leisure, work, consumption (e.g. relating to food), communities (e.g. relating to social networks or more generally to communication between several users), etc. According to another example, the first objects A₁, . . . , Aₓ comprise titles of texts, articles or summaries.

According to an illustrative example, the first objects A₁, . . . , Aₓ relate to the “learning” category. A first list L₁, . . . , Lₓ of first objects A₁, . . . , Aₓ comprises different pictograms representing various learning fields, such as music, history, languages or science.

Lists L₁, . . . , Lₓ of first objects A₁, . . . , Aₓ are positioned on first lines Lin₁, . . . , Linₓ on display E₁. The first objects A₁, . . . , Aₓ of each list L₁, . . . , Lₓ are distributed along a first line Lin₁, . . . , Linₓ.

Optionally, at least two first lines Lin₁, . . . , Linₓ are non-sequential on display E₁. For example, at least two first lines Lin₁, . . . , Linₓ are parallel to each other on the display E₁. According to another example, all the first lines Lin₁, . . . , Linₓ are parallel to each other on display E₁. According to another example, at least two first lines Lin₁, . . . , Linₓ are concentric circles on display E₁.

### Actuation and First User Command

With reference to FIGS. 1 to 6, 8A and 9, the method comprises a step of first actuating ACT₁ at least one first object to be actuated taken among the first objects A₁, . . . , Aₓ of a list of the plurality of lists L₁, . . . , Lₓ, by means of a first user command C₁. The first actuating ACT₁ comprises, for example, a step of selecting at least a first object A₁, . . . , Aₓ by means of the first user command C₁. The first user command C₁ comprises, for example, a predefined interaction between a user and the display E₁, via an input interface.

Optionally, the first user command C₁ is a digital command. By digital command we mean a command generated by digital interaction via direct physical contact of a user with the input interface.

Optionally, the first user command C₁ comprises a non-physical interaction with an input interface. This could be a movement of a body part, such as a blink of the eyes or a movement of the head. This non-physical interaction is detected, for example, by means of an input interface comprising a camera, an augmented reality device, a motion sensor for detecting movement, or any other suitable device.

Optionally, the first user command C₁ comprises a signal generated in response to a detection of a neurological activity of the user. For example, the first user command C₁ is automatically generated in response to the detection of a thought, or any other activity of the user's brain. This is enabled, for example, by means of a sensor that detects a particular electrical activity in the user's brain.

Optionally, actuation of a first object A₁, . . . , Aₓ by means of the first user command C₁ results in the display of a sub-list of Boolean operators. Boolean operators include, for example, “AND”, “OR” and so on. The sub-list of Boolean operators is displayed, for example, when the user operates a first object for a predetermined time, for example by maintaining a digital interaction on a first object displayed on a touch screen for a predetermined time. In one example, the user selects two objects from different lists and sub-lists and selects a Boolean operator to combine or exclude these objects from the query according to the selected operator.

Optionally, the first user command C₁ comprises the second user command C₂ and/or comprises the third user command C₃ and/or comprises the fourth user command C₄. The methods described for the first user command C₁ are directly applicable to the second user command C₂ and/or the third user command C₃ and/or the fourth user command C₄, and vice versa.

According to a first example, the display E₁ comprises a screen with a capacitive layer, such as a touch screen, and the first user command C₁ is a touch control. In this case, the touch screen is both an input and an output interface. The first user command C₁ comprises a single touch of the user's finger on the display E₁. In this example, the user activates a first object A₁, . . . , Aₓ by direct physical contact on said object with a finger.

In a second example, the display E₁ is connected to an input interface comprising a keyboard and a mouse. In this example, the first user command C₁ comprises a digital user interaction with said input interface.

In another example, the display E₁ is integrated into a virtual reality device, such as a virtual reality headset.

Optionally, the first user command C₁ is implemented by means of a tool capable of interacting with the display E₁. For example, when the display E₁ comprises a touch screen, it may be a tool whose contact is capable of being detected by the touch screen, such as a stylus.

Optionally, the first user command C₁ is a voice command.

According to an illustrative example, a voice command from a user is received by an input interface comprising a microphone. The signal resulting from the reception of the voice command by the microphone is then processed by a signal processing chain comprising a calculator to actuate the first object A₁, . . . , Aₓ. In this example, the calculator is configured to process the received signal and to identify specific characteristics of the signal, such as characteristic frequencies, the detection of which leads to the activation of at least one predetermined first object A₁, . . . , Aₓ.

In an embodiment, the actuation of at least a first object A₁, . . . , Aₓ by means of the first user command C₁ results in the automatic generation of a query. In one case, the results of such a query are automatically displayed in response to said query generation. For example, a request to display new lines of new first objects A₁, . . . , Aₓ, or a request to hide a line of first objects A₁, . . . , Aₓ, or first objects A₁, . . . , Aₓ in a line.

Automatic update of first objects With reference to FIGS. 1 to 6 and 9, the method comprises a step of first automatic updating MAJ₁, by the calculator CLC₁, of the first objects A₁, . . . , Aₓ of at least one list taken from the plurality of lists L₁, . . . , Lₓ distinct from the list to which the first object actuated by means of the first user command C₁ belongs. The automatic update MAJ₁ of the separate list results in the display of at least one new first object on the same line as that on which the first separate list objects A₁, . . . , Aₓ are displayed.

In the remainder of this description, “automatic update” refers to the display of new first objects in a list L₁, . . . , Lₓ. The new first objects displayed may be added to the pre-existing list, or they may replace the first objects previously displayed.

FIG. 9 illustrates an embodiment in which the first actuation ACT₁ causes a first automatic update MAJ₁, by the calculator CLC₁, of the set of first objects A₁, . . . , Aₓ in two first lists L₁, . . . , Lₓ. The first automatic update MAJ₁ causes new first objects A₁, . . . , Aₓ to be displayed on the first lines Lin₁, . . . , Linₓ on which said first two lists L₁, . . . , Lₓ are displayed.

Optionally, the first actuation ACT₁ causes the calculator CLC₁ to automatically update MAJ₁ for the first time at least one first object A₁, . . . , Aₓ in the same list as the actuated first object A₁, . . . , Aₓ. In this case, the first automatic update MAJ₁ results in the display of at least one new first object A₁, . . . , Aₓ in the list of the actuated first object A₁, . . . , Aₓ.

Optionally, the first actuation ACT₁ generates the query, for example a search query.

Optionally, the first actuation ACT₁ causes the calculator CLC₁ to display a new window on the display E₁. The new window is for example displayed above the first list L₁, . . . , Lₓ to which belongs the first actuated object A₁, . . . , Aₓ. The new window is for example displayed instead of one or more first lists L₁, . . . , Lₓ. The new displayed window includes, for example, a text or video relating to the actuated first object A₁, . . . , Aₓ. For example, if the actuated first object A₁, . . . , Aₓ relates to the search for a course for learning an instrument, the new window displays, for example, a demonstration video by a teacher of the instrument in question. According to another example, if the actuated first object A₁, . . . , Aₓ relates to learning the history of France, the new window displays, for example, a text relating to a given historical period. According to this embodiment, the first actuation ACT₁ causes the calculator CLC₁, for example, to generate a query submitted to a search engine, or a query submitted to a generative artificial intelligence engine, in order to obtain the most relevant result to display such as for example the URL of a video from a website, or a text from a website, or an information medium stored in a database on a remote server.

In a case where the display E₁ comprises a foldable screen, search results are for example displayed on the upper part of the screen, and object lists are for example displayed on the lower part of the screen.

### Second User Command: Query Generation

Referring to FIGS. 1 to 6, the method comprises a step of generating GEN_{req}, by the calculator CLC₁ and by means of a second user command C₂, a query, for example a search query.

For example, the second user command C₂ is used to generate the query. In another example, the query is generated by means of the first user command C₁.

According to an example, performing the second user command C₂ leads to a display of query results displayed on a new page, for example a page other than the page on which the results of the updated lists were displayed, for example the lists updated using the first user command C₁.

However, this does not rule out the second user command C₂ being identical to the first user command C₁ in terms of user interaction with a dedicated interface (touch screen, mouse/keyboard, microphone, etc.). For example, the second user command C₂ may comprise a digital command. It may be the same command as the first user command C₁, or a different one.

Optionally, the request, e.g. for a search, is generated by means of the calculator CLC₁ following actuation, by performing the second user command C₂ on a dedicated object displayed on the display E₁. In this case, the process includes a preliminary step of displaying said dedicated object on the display E₁. This dedicated object is, for example, a graphic element, a pictogram, or any other graphic representation that can be activated by the user to generate the request. Optionally, the request, e.g. for a search, is generated by the calculator CLC₁ following the actuation of a first object A₁, . . . , Aₓ by means of a user command resulting in a movement of at least a first object A₁, . . . , Aₓ on the display E₁.

According to an example in which the display E₁ is a touch screen, the user drags, by means of a touch control, one or more first objects A₁, . . . , Aₓ to a predetermined area of the screen to generate the query. In this example, query parameters P_{req} are defined using information associated with the first objects A₁, . . . , Aₓ operated by the user. The query parameters P_{req} define, for example, a filter to segment the search results only to relevant results. In one example, a first first object A₁, . . . , Aₓ symbolizes an aircraft and a second first object A₁, . . . , Aₓ symbolizes Japan. In this first example, several user commands have been implemented beforehand to display these first objects A₁, . . . , Aₓ, starting from a higher search granularity, for example starting from a “transport” category and a “destination” or “country” category. The user then drags the first objects A₁, . . . , Aₓ to a predetermined area to initiate a query for flights to Japan. In this example, other parameters can be taken into account, including timestamp parameters and user profile parameters. For example, a list of first objects A₁, . . . , Aₓ symbolizes different user profiles (e.g. a single man, a couple and a child, a group of four adults . . . ), and another object is used to define a desired date and time for the trip. In this case, these objects are, for example, dragged by the user to the predetermined zone by means of a command to initiate the search, taking into account these additional query parameters P_{req}.

Optionally, the request is generated by the calculator CLC₁ following the actuation of a predetermined number of first objects A₁, . . . , Aₓ by the user by means of a command, such as the first user command C₁.

Optionally, the query is generated following the user's actuation, by means of a command, of at least one object from each of the lists displayed on the display E₁.

Optionally, the first user command C₁ and the second user command C₂ are the same command. In this case, for example, the request is generated by the calculator CLC₁ immediately following the user's actuation, by means of the first user command C₁, of one or more first objects A₁, . . . , Aₓ.

### Second Actuation and Third User Command

Optionally, with reference to FIG. 2, the method comprises a step of second actuation ACT₂ of a second actuated object taken from among the first objects A₁, . . . , Aₓ of a list L₁, . . . , Lₓ, by means of a third user command C₃, said second actuation ACT₂ resulting in retrieval of values of digital entities stored in a first memory MEM₁, each of said digital entities being associated with the second actuated object. Optionally, said digital entities are also associated with the first actuated object.

The MEM₁ memory includes, for example, a remote data server, a website or web page address, a local memory of a device comprising the display E₁, or a shared resource storage unit accessible by means of a telecommunications network, also known as a “cloud”.

Optionally, the memory MEM₁ includes data processed by a learning function. A learning function is defined as an automatic learning algorithm that enables a mathematical model to adapt to data according to a goal. The learning function is, for example, a supervised learning algorithm, an unsupervised learning algorithm or a reinforcement learning algorithm. The model used comprises, for example, a neural network such as a convolutional neural network.

Neural networks are classes of non-linear models organized in layers, composed of a number of interconnected nodes containing activation functions. Models can be presented to the network via an input layer connected to hidden layers, and processing can be performed via weighted node connections. The response is then provided by an output layer connected to the hidden layers. A convolutional neural network is a neural network that is a regularized version of a multilayer perceptron. A multilayer perceptron is a class of neural networks that uses a supervised learning technique to distinguish between data that are not linearly separable.

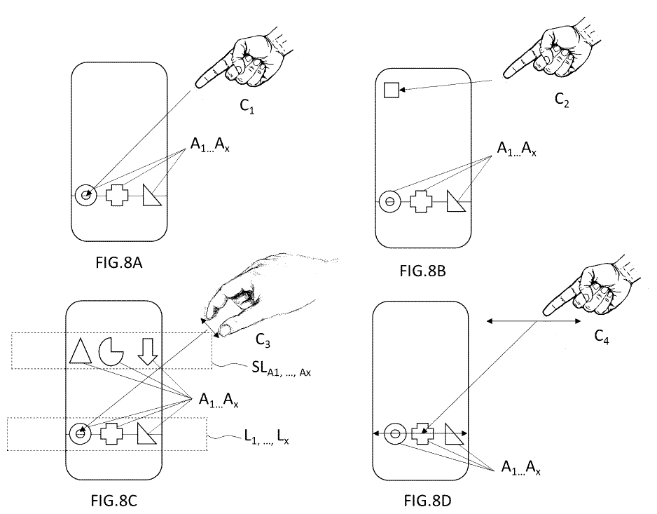

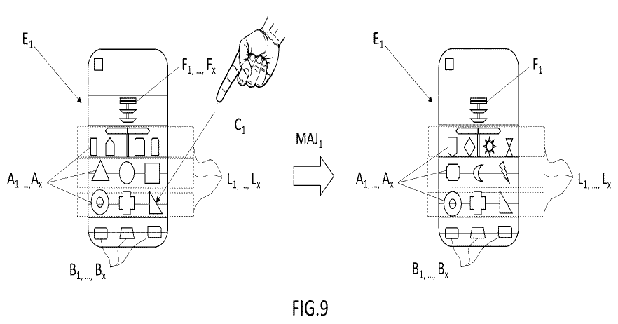

The third user command C₃ corresponds to an interaction between a user and the display E₁, whether or not via an input interface. Optionally, the third user command C₃ is a digital command, such as a touch command. In an example shown in FIG. 8C, the third user command C₃ is a tactile command in which the user places two fingers on the display E₁ and spreads his fingers apart to “zoom” the screen.

In another example, the third user command C₃ is a double-click performed by means of a pointer, for example a stylus adapted for use on a touch screen. In another example, not illustrated, the third user command C₃ corresponds to a double-click on an object displayed on the E₁ display. This is made possible, for example, when the display E₁ is connected to an input interface comprising a mouse, or any other pointing device.

### Sub-Lists of First Objects

Optionally, with reference to FIG. 2, the method comprises a step of second display AFF₂, by means of the calculator CLC₁ and in response to the third user command C₃, of a sub-list SL_{A1, . . . , Ax} of first objects A₁, . . . , Aₓ on the display E₁. The sub-list SL_{A1, . . . , Ax} of first objects A₁, . . . , Aₓ is displayed on a second line 2Lin₁, . . . , 2LINₓ. The second line 2Lin₁, . . . , 2LINₓ is, for example, a line parallel to a first line Lin₁, . . . , LINₓ. According to another example, the second line 2Lin₁, . . . , 2LINₓ is merged with a first line Lin₁, . . . , LINₓ. According to another example in which at least one list L₁, . . . , Lₓ of first objects A₁, . . . , Aₓ is displayed on a circle, the sub-list SL_{A1, . . . , Ax} of first objects A₁, . . . , Aₓ is displayed on a circle concentric with said circle. The sublist SL_{A1, . . . , Ax} of first objects A₁, . . . , Aₓ symbolizes, for example, subcategories of first objects A₁, . . . , Aₓ. For example, if a first object A₁, . . . , Aₓ symbolizes a “transport” category, the first objects A₁, . . . , Aₓ of the sub-list SLA₁, . . . , Aₓ symbolize categories such as “airplanes”, “boats”, “cars”, etc. In another example, the first objects A₁, . . . , Aₓ symbolize sub-categories of the sub-list SL_{A1, . . . , Ax}. In another example, the first objects A₁, . . . , Aₓ in the list L₁, . . . , Lₓ refer to musical instruments, and the first objects A₁, . . . , Aₓ in the sub-list SL_{A1, . . . , Ax} symbolize different instrument categories. For example, in response to the actuation of a first object A₁, . . . , Aₓ representing a guitar, a sub-list SL_{A1, . . . , Ax} of first objects A₁, . . . , Aₓ may comprise different first objects A₁, . . . , Aₓ associated with categories such as “acoustic”, “electro-acoustic”, “electric”.

Optionally, at least one first object A₁, . . . , Aₓ of the sub-list SL_{A1, . . . , Ax} can be operated by means of a user command. This is, for example, the first user command C₁, or the third user command C₃. According to one example, actuating a first object A₁, . . . , Aₓ of a sub-list SL_{A1, . . . , Ax} enables access to another sub-list of first objects A₁, . . . , Aₓ. In the previous guitar example, activating a first object A₁, . . . , Aₓ associated with the electro-acoustic category enables for example access to another sub-list of first objects A₁, . . . , Aₓ associated with brands, such as “Taylor”, “Baton Rouge”, “Yamaha”, etc.

Optionally, the actuation of a first object A₁, . . . , Aₓ of one of the sub-lists SL_{A1, . . . , Ax} enables new query parameters P_{req} associated with the actuated object to be defined. Optionally, the actuation of a first object A₁, . . . , Aₓ of one of the sub-lists SL_{A1, . . . , Ax} leads to the generation of the query, for example a search query, controlled by the calculator CLC₁.

Optionally, the query is generated automatically by the calculator CLC₁ following the actuation of at least one first object A₁, . . . , Aₓ from each list L₁, . . . , Lₓ and/or sub-list SL_{A1, . . . , Ax} displayed on the display E₁.

Optionally, the request, e.g. for a search, is generated automatically by the calculator CLC₁ following actuation of at least one object from the set of last sub-lists SL_{A1, . . . , Ax} of each of the first lists L₁, . . . , Lₓ. By “last sub-lists” we mean the finest granularity, e.g. search granularity, that it is possible to obtain or require for a given list of objects. For example, if a list of first objects SL_{A1, . . . , Ax} corresponds to musical instruments displayed in an online musical instrument sales portal, the last sub-list SL_{A1, . . . , Ax} will correspond, for example, to a list of models of a given brand of acoustic guitars.

For example, if a list L₁, . . . , Lₓ of first objects A₁, . . . , Aₓ corresponds to musical instruments displayed in an online portal for accessing musical instrument repair services, the last sub-list SL_{A1, . . . , Ax} will correspond, for example, to a list of components, such as strings, pegs, bridges, or accessories offered for sale, such as picks, tabs, tuners, capo, etc.

### First Positioning and Fourth User Command

Optionally, the method comprises a first positioning step POS₁ of a first object to be positioned taken among the first objects A₁, . . . , Aₓ of a list L₁, . . . , Lₓ, or of a sub-list SL_{A1, . . . , Ax}. The first positioning step POS₁ scrolls the objects in a list or sub-list according to the line on which they are displayed. In this way, a list of objects is not limited to the size of the display E₁ but can include many other objects that the user can have displayed on the screen via a user command.

This first positioning step is carried out, for example, by means of a fourth user command C₄. The fourth user command C₄ corresponds to an interaction between a user and the display E₁, whether or not via an input interface.

Optionally, the fourth user command C₄ is a digital command, such as a touch command.

In an example shown in FIG. 8D, the fourth user command C₄ is a touch command in which the user places a finger on the display E₁ and slides it over said display E₁ to scroll through a list. In another example, the fourth user command C₄ is a maintained interaction on display E₁ performed by means of a pointer, for example a stylus adapted for use on a touch screen, which is then moved across the screen to scroll through a list of objects.

In another, non-illustrated example, the fourth user command C₄ corresponds to a command held pointed at an object displayed on the display E₁ and moving the pointer. This is made possible, for example, when the display E₁ is connected to an input interface comprising a mouse or other pointing device. This involves, for example, pointing at the object using the pointing device or a cursor, and “clicking” the mouse.

### Reference Lines and Circle Lines

Optionally, at least one first object A₁, . . . , Aₓ is positioned, by means of the fourth user command C₄, at an intersection between the first line Lin₁, . . . , Linₓ on which is displayed said first object A₁, . . . , Aₓ and a reference line Lin_{ref}. The reference line Lin_{ref} is, for example, perpendicular to the first line Lin₁, . . . , Linₓ. The reference line Lin_{ref} is for example centered on the display E₁. According to another example, the reference line Lin_{ref} passes through the center of a circle displayed on the display E₁. According to another example, the reference line Lin_{ref} follows any trajectory on the display E₁.

Optionally, at least the first two lines Lin₁, . . . , Linₓ are concentric circles and the reference line Lin_{ref} is a radius of the circle with the largest diameter.

Optionally, the query is automatically generated by the calculator CLC₁ by means of query parameters P_{req} associated with the set of objects positioned on the reference line Lin_{ref}.

Optionally, the query is generated by the calculator CLC₁ in response to the second user command C₂ by means of query parameters P_{req} associated with the set of objects positioned on the reference line Lin_{ref}.

Optionally, with reference to FIG. 4, the process comprises a second positioning step POS₂ of a second object to be positioned, taken among the first objects A₁, . . . , Aₓ of another list L₁, . . . , Lₓ or sub-list SL₁, . . . , SLₓ than that to which belongs another first object A₁, . . . , Aₓ already activated by the user. The second positioning step POS₂ is implemented, for example, by means of the fourth user command C₄. The second positioning step POS₂ is used, for example, to position the second object to be positioned at an intersection between the first line Lin₁, . . . , Linₓ, on which said first object A₁, . . . , Aₓ is displayed, and the reference line Lin_{ref}.

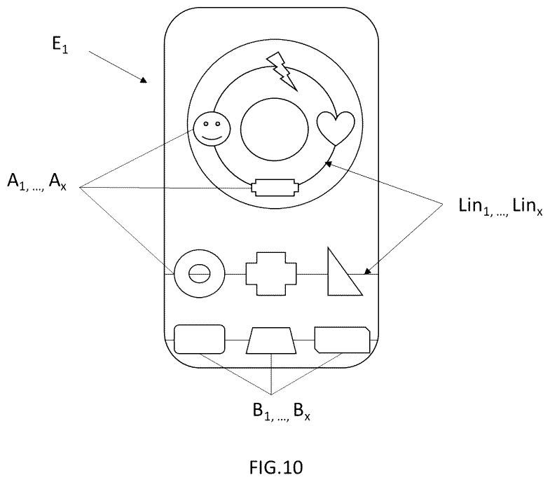

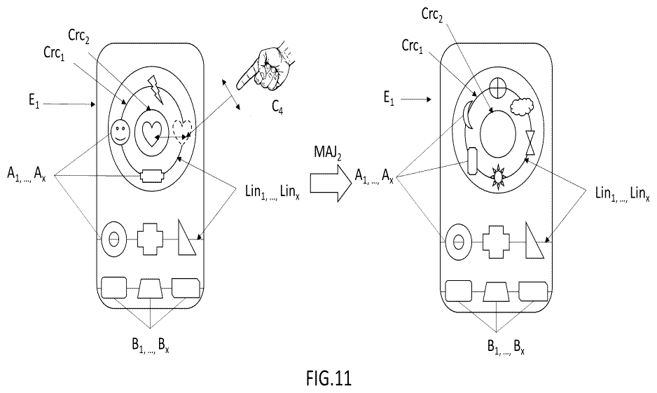

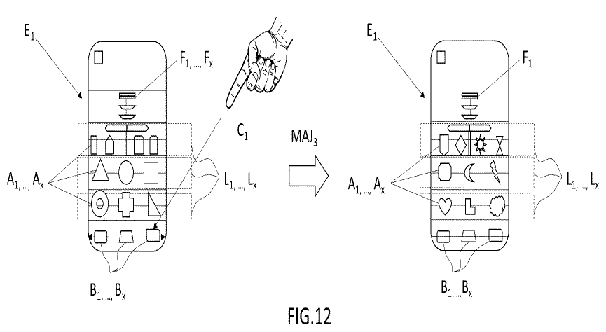

Optionally, with reference to FIGS. 10 and 11, at least one first line Lin₁, . . . , Linₓ is a first circle Crc₁.

Optionally, the method comprises a third positioning step POS₃ of at least one third object to be positioned taken from the first objects A₁, . . . , Aₓ displayed on the first circle Crc₁, inside a second circle Crc₂ of smaller radius than the radius of the first circle Crc₁, said third positioning POS₃ causing a second automatic update MAJ₂, by the calculator CLC₁, of the first objects A₁, . . . , Aₓ positioned on said first circle Crc₁.

Optionally, the query is generated by the calculator CLC₁ by means of query parameters P_{req} associated with at least a first object A₁, . . . , Aₓ positioned in the second circle Crc₂.

### List Updates

Optionally, the method comprises automatic updating, by means of an application programming interface comprising at least one software application, of at least one list L₁, . . . , Lₓ or at least one sub-list SL_{A1, . . . , Ax} of first objects A₁, . . . , Aₓ.

Optionally, at least one list of first objects SL_{A1, . . . , Ax} of first objects A₁, . . . , Aₓ is updated by the calculator CLC₁ by means of data stored in a memory, for example data generated by means of a generative artificial intelligence algorithm. The memory may comprise a remote data server, an Internet site or page address, a local memory of a device comprising the display E₁, or a shared resource storage unit accessible from by means of a telecommunications network.

### Third Object: Timestamp Parameters

Optionally, with reference to FIG. 5, the method comprises a third display step AFF₃ on the display E₁ and by means of the calculator CLC₁, of at least a third object F₁, . . . , Fₓ associated with digital entity values stored in a memory, said digital entity values comprising timestamp parameters.

Optionally, the third object F₁, . . . , Fₓ can be operated by means of any of the following user commands: the first user command C₁, the second user command C₂, the third user command C₃, the fourth user command C₄.

The user commands can be used, for example, to define time and date parameters that can be taken into account in the query parameters, for example to define a date and time for a trip, or to book a cinema screening or a lesson in a musical instrument.

Optionally, the query is generated by means of parameters associated with at least one first object A₁, . . . , Aₓ actuated and timestamp parameters associated with the third object F₁, . . . , Fₓ.

### Second Objects and Multi-Criteria Queries

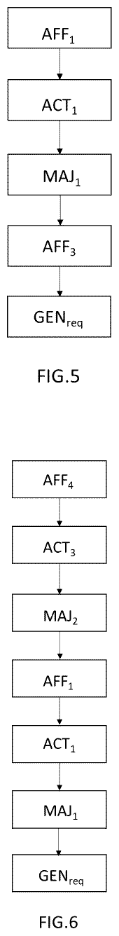

Optionally, with reference to FIGS. 6, 7 and 9, the process comprises a fourth display step AFF₄, on the display E₁ and by means of calculator CLC₁, of a list of second objects B₁, . . . , Bₓ.

The second objects B₁, . . . , Bₓ represent, for example, categories of user profiles such as “work”, “leisure”, “home”, and so on.

According to one example, a second object B₁, . . . , Bₓ symbolizes a “work” category, and lists of first objects A₁, . . . , Aₓ are associated with this second object B₁, . . . , Bₓ and symbolize lists of projects (code revision, field test, market launch, etc.), lists of people (generic person, user, subordinates, colleagues, boss, customers, etc.), lists of workplaces (head office, branch office, cafeteria, etc.), and a third object A₁, . . . , Aₓ symbolizing a “work” category.), lists of people (generic person, user, subordinates, colleagues, boss, customers, etc.), lists of workplaces (head office, branch office, cafeteria, etc.), and a third object F₁, . . . , Fₓ associated with date and time parameters (to define a date and time for meetings, conferences, events, etc.).

For example, the first object A₁, . . . , Aₓ when the “work” object is selected, includes secure, built-in user-specific parameters, such as gender, date of birth, office address, business telephone, business credit card, preferences, etc. According to another example, when the “home” object is selected, the first object A₁, . . . , Aₓ under the person lists includes secure, built-in user-specific parameters, such as gender, date of birth, home address, home phone, home credit card, preferences (e.g. cheapest), family details, etc. These parameters facilitate transactions by helping to identify the user's preferences. These parameters facilitate transactions by helping users to avoid entering and re-entering their personal basic details for each request.

According to another example, second objects B₁, . . . , Bₓ symbolize user profile categories such as “doctor”, “gardener”, “lawyer”, etc., as professions. According to one example, a second object B₁, . . . , Bₓ symbolizes a “doctor” category, and lists of first objects A₁, . . . , Aₓ are associated with this second object B₁, . . . , Bₓ and include lists of specialties (heart, brain, ENT, etc.), lists of people (team of doctors, etc.) and lists of professions.), lists of people (team, nurses, director, patients, etc.), lists of places (hospital, clinic, pharmacy, etc.), and a third object F₁, . . . , Fₓ is associated with date and time parameters (to define a date and time for operations, conferences, events, etc.).

The second objects B₁, . . . , Bₓ are displayed, for example, on a third line 3Lin₁, . . . , 3LINₓ on the display E₁. The third line 3Lin₁, . . . , 3LINₓ is for example parallel to a first line Lin₁, . . . , LINₓ or a second line 2Lin₁, . . . , 2LINₓ. According to another example, the third line 3Lin₁, . . . , 3LINₓ is a circle concentric with another circle on which first objects A₁, . . . , Aₓ are displayed.

Optionally, at least one second object B₁, . . . , Bₓ is operable by means of any of the first user command C₁, the second user command C₂, the third user command C₃ and the fourth user command C₄.

Optionally, actuating a second object B₁, . . . , Bₓ by means of a user command automatically updates the set of lists of first objects A₁, . . . , Aₓ displayed on the display E₁.

The second objects B₁, . . . , Bₓ symbolize, for example, broader categories than the lists of first objects A₁, . . . , Aₓ. According to one example, a second object B₁, . . . , Bₓ symbolizes a “travel” category, and lists of first objects A₁, . . . , Aₓ are associated with said second object A₁, . . . , Aₓ and include lists of modes of transport (plane, car, boat, train), lists of user profiles (single traveler, couple), lists of destinations, a third object associated with time-stamping parameters (for defining an arrival date and time). The inventive concepts is not limited to the aforementioned example, and is applicable in many other fields (learning, booking various leisure activities, booking hotels, generating objects by means of generative artificial intelligence, etc.).

Optionally, the query parameters P_{req} comprise a plurality of parameters associated with first objects A₁, . . . , Aₓ displayed consecutively to the selection of at least two different second objects B₁, . . . , Bₓ. In this way, it is possible to combine several different searches within the scope of the inventive concepts. For example, it is possible to combine the booking of a Paris-Tokyo journey with the booking of a train to Shinjuku from Haneda airport, with the booking of a hotel and a cinema screening on the day of arrival.

According to an embodiment, the display E₁ is configured to display at least a fourth object G₁, . . . , Gₓ. The fourth object G₁, . . . , Gₓ is, for example, associated with meteorological parameters. The fourth object G₁, . . . , Gₓ is, for example, associated with location parameters. These parameters are displayed, for example, on the fourth object G₁, . . . , Gₓ.

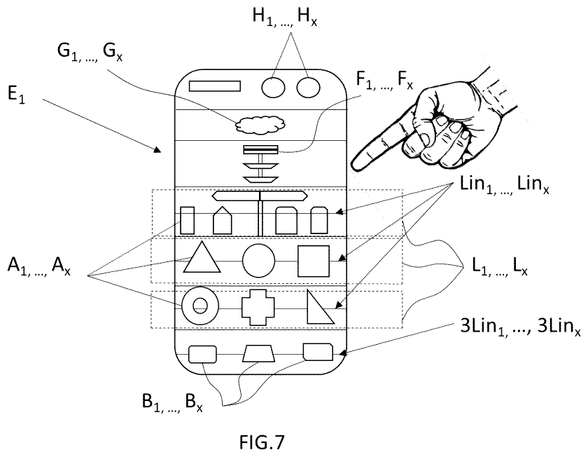

For example, the fourth object G₁, . . . , Gₓ is displayed as a pictogram centered on the screen as shown in FIG. 7, and weather information is displayed on said pictogram.

In an embodiment, the location and/or weather parameters are displayed on at least one other object among the set of objects displayed on display E₁.

According to another example, the fourth object G₁, . . . , Gₓ comprises lines of text relating to a newspaper article, for example the title of a relevant article relating to query parameters associated with a first activated object A₁, . . . , Aₓ.

Optionally, actuating any of the objects displayed on the display E₁ by means of one of the user commands causes a web page to be displayed on the display E₁. For example, in the aforementioned example in which the title of a newspaper article is displayed on the fourth object G₁, . . . , Gₓ, the actuation of the fourth object G₁, . . . , Gₓ by means of a user command, for example the first user command C₁, results in the display of a web page on which the entire article is displayed.

Optionally, the actuation of at least one first object A₁, . . . , Aₓ, second object B₁, . . . , Bₓ, or third object F₁, . . . , Fₓ, results in automatic updating of the fourth object G₁, . . . , Gₓ. This automatic update involves, for example, the modification of parameters displayed on the fourth object G₁, . . . , Gₓ, for example weather or location information to display the weather forecast for the selected city where the user plans to go at the specified future date, or traffic, or a map of this location, or the display of new information, for example the title of a newspaper article and an associated date.

For example, the fourth object G₁, . . . , Gₓ is displayed on a line of the display E₁ separate from the lines on which the first objects A₁, . . . , Aₓ are displayed. The fourth object G₁, . . . , Gₓ is displayed, for example, on a line of the display E₁ separate from the lines on which the second objects B₁, . . . , Bₓ are displayed. The fourth object G₁, . . . , Gₓ is displayed, for example, on a line of the display E₁ separate from the line on which the third object F₁, . . . , Fₓ is displayed.

Optionally, the fourth user command C₄ is used to scroll through fourth objects G₁, . . . , Gₓ to display new fourth objects G₁, . . . , Gₓ.

In an embodiment, the display E₁ is configured to display at least a fifth object H₁, . . . , Hₓ comprising at least one input field. By “input field” we mean a graphic entity capable of receiving query parameters. These are, for example, query parameters associated with a first object A₁, . . . , Aₓ of a list of sub-list SL_{A1, . . . , Ax}, or third objects F₁, . . . , Fₓ of a list or sub-list. Query parameters are, for example, entered in the input field in response to a user command. An example of this is the first user command C₁. It can also be any of the second, third and fourth user commands.

According to an illustrative example, the query parameters entered in the input field comprise parameters associated with a first object A₁, . . . , Aₓ positioned in the input field of the fifth object H₁, . . . , Hₓ by means of the fourth user command C₄. Graphically, this is illustrated, for example, by the positioning of a pictogram relating to a first object A₁, . . . , Aₓ inside another pictogram relating to a fifth object H₁, . . . , Hₓ. The positioning of a pictogram relating to a first object A₁, . . . , Aₓ inside another pictogram relating to a fifth object H₁, . . . , Hₓ results, for example, in the storage, in a memory, of the parameters associated with said first positioned object A₁, . . . , Aₓ.

Optionally, the query is generated by means of parameters associated with at least a first object A₁, . . . , Aₓ positioned within a fifth object H₁, . . . , Hₓ.

Optionally, the display E₁ is configured to display a graphical query element, such as a search bar. The search query is generated, for example, by means of search parameters associated with a first object A₁, . . . , Aₓ actuated and/or a second object B₁, . . . , Bₓ actuated, and/or a third object F₁, . . . , Fₓ actuated, and/or a fourth object G₁, . . . , Gₓ actuated, and/or a fifth object H₁, . . . , Hₓ actuated by any one of the first, second or third user commands C₁, C₂, C₃.

Optionally, actuation of one of the first objects A₁, . . . , Aₓ, the second objects B₁, . . . , Bₓ, the third objects F₁, . . . , Fₓ, the fourth objects G₁, . . . , Gₓ and the fifth objects H₁, . . . Hₓ causes the calculator CLC₁ to automatically update at least one first object A₁, . . . , Aₓ and/or one second object B₁, . . . , Bₓ and/or one third object F₁, . . . , Fₓ and/or one fourth object G₁, . . . , Gₓ and/or one fifth object H₁, . . . , Hₓ distinct from the actuated object.

According to one example, activating a first object A₁, . . . , Aₓ from a list relating to a historical period such as the First World War results in the display of the dates “1914-1918” as a third object F₁, . . . , Fₓ, or other objects symbolizing the wikipedia page relating to this historical period. The data associated with the first objects A₁, . . . , Aₓ, second objects B₁, . . . , Bₓ, third objects F₁, . . . , Fₓ, fourth objects G₁, . . . , Gₓ and fifth objects H₁, . . . , Hₓ may come from a memory or from web data obtained by means of a URL, for example the web address of “Wikipedia”.

Optionally, display E₁ is configured to display a plurality of lists of first objects A₁, . . . , Aₓ list of second objects B₁, . . . , Bₓ, a list of third objects F₁, . . . , Fₓ, a list of fourth objects G₁, . . . , Gₓ, and a list of fifth objects H₁, . . . , Hₓ.

According to an illustrative example, the display E₁ is configured to display a list of second objects B₁, . . . , Bₓ relating to different fields (culture, business, travel, shopping, etc.). Selecting one of the second objects B₁, . . . , Bₓ from the list results in the display E₁ showing three lists of first objects A₁, . . . , Aₓ relating to the second object B₁, . . . , Bₓ selected. For example, if the selected second object B₁, . . . , Bₓ relates to the business domain, the first list of first objects A₁, . . . , Aₓ comprises, for example, first objects A₁, . . . , Aₓ relating to different business-related categories (urban planning, defense, etc.), the second list of first objects A₁, . . . , Aₓ relates to the business domain, and the third list of first objects A₁, . . . , Aₓ relates to the business domain, the second list of first objects A₁, . . . , Aₓ comprises, for example, a selection of web newspaper articles relating to the business category, and the third list of first objects A₁, . . . Aₓ comprises, for example, a list of continents (operable by means of the first user command C₁ or the third user command C₃ to display a sub-list of countries, and then operable by means of the first user command C₁ or the fourth user command C₄ to filter the articles by territory. The Display E₁ is configured to display at least a third object F₁, . . . , Fₓ which includes, for example, the date and time of day. The Display E₁ is also configured to display a fourth object G₁, . . . , Gₓ comprising a date and a newspaper name relating to an article associated with an actuated first object A₁, . . . , Aₓ.

In an embodiment, the object lists are organized into at least seven different lists. These are, for example, lists of first objects A₁, . . . , Aₓ. The seven lists are taken, for example, from the following lists: interest, rhythm, passion, temporality, people, place, objective and profile.

According to an illustrative example, in which the object lists relate to a multimedia content company, the “objective” list includes objects relating to the following content: radio, films, events, newsletters, magazine, etc. The “interest” list includes objects relating to different contents: politics, culture, history, science, music, sports etc. And so on for all lists.

The object lists in the above example comprise, for example, objects from the first objects A₁, . . . , Aₓ, second objects B₁, . . . , Bₓ, third objects F₁, . . . , Fₓ, fourth objects G₁, . . . , Gx and fifth objects H₁, . . . , Hₓ.

This case study illustrates that the inventive concepts makes it possible to generate a complex query while enabling a user to navigate easily, optimized and instinctively through all the data relating to his or her search.

Optionally, the calculator CLC₁ is configured to scroll at least one object from at least one list or at least one set of objects among the first objects A₁, . . . Aₓ, second objects B₁, . . . , Bₓ, third objects F₁, . . . , Fₓ, fourth objects G₁, . . . , Gₓ and fifth objects H₁, . . . , Hₓ on the display E₁. The calculator CLC₁ is configured, for example, to scroll through the objects on their respective lines.

Optionally, the automatic scrolling of at least one object along its respective line results in the automatic display of at least one new object on the display E₁, controlled by the calculator CLC₁.

In an embodiment, one or a plurality of objects in a list are de-displayed in response to processing of user preference data by a calculator. For example, user profile data can be used by the calculator to calculate an interest score. Such an interest score is, for example, associated with search results/query suggestions materialized by objects displayed on lists. Objects with an interest score below a predetermined, configurable or self-adjusting threshold, for example, are hidden from display.

One advantage is that it takes user preferences into account, displaying only results/suggestions of query items that are relevant to the user. Another advantage is to optimize the space occupied on the display. Another advantage is to prevent the user from getting lost in “rabbit holes” that would divert him from his initial search.

Optionally, the display E₁ is configured to de-display at least one list of first objects A₁, . . . , Aₓ, second objects B₁, . . . , Bₓ, third objects F₁, . . . , Fₓ, fourth objects G₁, . . . , Gₓ or fifth objects H₁, . . . , Hₓ in response to a user command. This is, for example, the fourth positioning user command. For example, each list includes an associated pictogram, and positioning said pictogram in a predefined area of display E₁ causes said list to be de-displayed. The list can then be redisplayed in response to a user command on the E₁ display, for example a digital command at the E₁ display location on the predefined zone where the pictogram associated with said list has been positioned. In this way, the inventive concepts makes it possible to organize data in an instinctive way for the user.

This option is advantageous, for example, when text, such as a newspaper article, is displayed following the actuation of an object. This enables the user to reduce lists and access more text on the display. He can then, for example, re-actuate one of the pictograms associated with a list to redisplay his lists and initiate a different search.

Other possible examples are the purchase or reservation of goods or services, the booking of tickets for events, and in general, any type of request aimed at accessing informative content (e.g. newspapers, scientific articles, historical articles, wikipedia pages) or entertainment (radio programs, entertaining videos, streaming music) targeted or aimed at purchasing, renting or reserving goods or services according to precise criteria: newspapers, scientific articles, historical articles, wikipedia pages) or entertainment (radio programs, entertainment videos, streaming music) targeted at buying, renting or reserving goods or services according to specific criteria (e.g. location, dates and times, type of event sought, means of transport sought, budgetary constraints, user profile constraints (a single person, a couple with a child, etc.) through the use of user filters.) via search filters obtained by clicking on one or more objects in one or more lists.

Thus, advantageously, the inventive concepts makes it possible to generate complex multi-criteria queries in a simplified way for a user, while allowing him to navigate easily through a large number of data, whatever the writing language, which are organized in a structured way through the various object lists. Another advantage of the inventive concepts is to encourage the user's curiosity and learning by displaying a multitude of objects likely to attract his attention in a universal, playful and instinctive way. The inventive concepts is particularly applicable to websites. It makes it possible to offer a user more instinctive navigation and to promote the recognition and recall of parameters to more easily reach the result of his query, for example a search (e.g. a specific podcast in the field of entrepreneurship applied to retailing in Portugal), while drawing his attention to other subjects or documents likely to be of interest to him through the display of different objects in different lists.

Encoding digital portals

In an embodiment, the process comprises a step of encoding at least one digital portal.

The encoding of the digital portal results, for example, in the generation of a graphical interface comprising several modalities, such as visual, haptic or auditory modalities. The generated graphical interface enables the user, for example, to interact with various elements or actuatable objects. These interactions can include launching search queries, accessing documents, applications or databases, and browsing various online content or services. An encoded digital portal, for example, provides a single point of entry, simplifying the user's access to a plurality of resources.

Optionally, the digital portal encoding step includes a personalization step.

One advantage is to generate a graphical interface comprising several modalities adapted to the user's specific needs.

Another advantage is a consistent, intuitive user experience.

Optionally, the digital portal is encoded using one or more of the following computer languages: HTML (“HyperText Markup Language”), CSS (“Cascading Style Sheets”) and JavaScript.

Optionally, the digital portal encoding step includes the use of one or more frameworks.

Optionally, the digital portal encoding step includes the use of a backend stage. Optionally, the digital portal encoding step includes the use of at least one API (Application Programming Interface).

One advantage is that a front end can be connected to one or more databases and/or one or more output stages (or back-ends).

Optionally, the digital portal encoding step includes the use of at least one database. Examples of databases that can be used include, but are not limited to, MySQL, PostgreSQL, MongoDB, or cloud solutions such as Firebase or AWS DynamoDB.

Optionally, the digital portal encoding step includes a step for implementing an authentication method, for example “OAuth” or “JWT”, or any other suitable method.

Optionally, the digital portal encoding step includes a step for accessing one or more libraries. Examples of libraries include, but are not limited to, JavaScript, “jQuery”, “Axios”, “D3.js”, or any other type of suitable library.

Optionally, the step of encoding the digital portal includes the implementation of a test tool for said portal, such as a test tool to ensure its reliability, for example “Jest”, “Mocha”, etc.

Optionally, the method comprises a step of downloading an address, content and/or application for encoding a digital portal. This step is implemented, for example, via a user's access to a remote data server, or a user's access to a personal digital portal.

In an embodiment, the encoding step of the digital portal comprises a consideration of content parameters. The content parameters include, but are not limited to, market parameters, such as a parameter estimating that a user is looking for a particular product and/or service to buy and/or book, media parameters, such as a parameter estimating that a user is looking for particular information relating to a particular domain, or parameters intrinsic to the user, such as a parameter estimating that a user wishes to organize data or files according to a particular logical scheme.

According to an embodiment, the encoding step of the digital portal includes taking into account data format parameters. Data format parameters include, but are not limited to, prices, schedules, titles, articles, project names and multimedia files.

According to an embodiment, the step of encoding the digital portal comprises a step of analyzing previous data. By example, an analysis of data characterizing user feedback, for example in the form of ratings or reviews, can be taken into account to encode the digital portal.

In an embodiment, the method comprises receiving, by means of a communication interface, a request to encode at least one digital portal. This is, for example, a request to encode a pre-existing digital portal in order to modify it in the form of a graphical interface according to the inventive concepts, for example a multimodal graphical interface. The request comprises, for example, a digital address of the pre-existing portal, for example an address of the portal accessible via a data server. The method comprises, for example, a step of analyzing data from the request and/or data from the pre-existing portal to determine a number of encoding parameters. The determined encoding parameters can be determined from a plurality of pre-existing encoding sequences each comprising several encoding parameters. The encoding parameters may be determined automatically, extracted from a memory on which they are stored, or a combination of these options. Examples of predetermined encoding sequences include a media sequence (e.g. encoding in newspaper form, displaying headlines in predetermined fonts, displaying data in the form of articles, etc.), a market sequence (e.g. encoding in the form of lists and sub-lists of categories relating to categories of sales items for an online sales platform, etc.).

In an embodiment, the encoding of the digital portal comprises the encoding of user-configurable layers. This encoding of parameterizable layers is implemented, for example, in one or more encoding sequences. Whether or not this option is implemented depends, for example, on an analysis of an encoding request submitted by the user. These parameterizable layers include, for example, layers for entering various parameters, such as timestamp parameters, user preference parameters (user's areas of interest, display preferences, etc.).

In an embodiment, encoding of the digital portal comprises automatic encoding of one or more encoding layers determined automatically by a calculator using user data. According to one example, the calculator is configured to assign data to specific encoding layers based on an analysis of this data. For example, a location layer may be encoded by means of data relating to positions, settings, sites, etc.; a user layer may be encoded by an analysis of age data, personal data, professional data, conversation data, etc.; a project layer may be encoded by an analysis of meeting data, presentation data, contract data; an application layer may be encoded by means of game data, productivity data, media data, etc.; a user layer may be encoded by an analysis of age data, personal data, professional data, conversation data, etc.; a user layer may be encoded by an analysis of age data, personal data, professional data, conversation data, etc.; a project layer may be encoded by an analysis of meeting data, presentation data, contract data; an application layer may be encoded by means of game data, productivity data, media data, etc.

Optionally, the process includes a step of analyzing data from one or more encoding layers to automatically generate encoding sublayers. For example, the calculator is configured to automatically analyze data from a transport layer, and to generate several sub-layers according to a modality of environment of use of the transport mode (e.g.: a “road” sub-layer comprising cars, trucks, bicycles, etc., a “rail” sub-layer comprising trains of various categories, an “air” sub-layer comprising airplanes, hot-air balloons, helicopters, etc.). This mode of implementation can be applied to any type of encoding layer (e.g. a “learning” layer comprising “music”, “language”, “science” sublayers, etc.).

Optionally, the process includes a step of analyzing sub-layer data to automatically encode sub-layers of sub-layers. This option can be implemented as many times as required to define sub-categories of categories specifying search terms.

Optionally, the encoding of a layer or sublayer is based on an analysis of a data distribution.

Optionally, the encoding of a layer or sub-layer is based on the automatic generation of a predictive score. For example, data layers can be encoded when a predictive score exceeds a threshold value characterizing a probability of search term association. For example, such a score may characterize a probability that a user searching for certain terms or using certain search parameters is likely to include other specific parameters in his query (for example, a user searching for a location and a flight would be likely to search for accommodation). This prediction score is based, for example, on an analysis of other users'data. For example, a probability of a user accessing a given piece of content when they have previously accessed another specific piece of content can be determined by analyzing data from other users.

In an embodiment, the encoding of the digital portal comprises the use of a predetermined template. The predetermined template is, for example, automatically transmitted to the user based on an analysis, by the calculator, of query parameters transmitted by said user. According to an illustrative example, a request transmitted by a user by means of an electronic device is received via a server connected to a data network and automatically processed by the calculator to determine encoding parameters and to determine a predetermined template as a function of said determined parameters. The user's request may include, for example, answers to a questionnaire to understand the user's needs. Optionally, a plurality of predetermined models are transmitted to the user in response to receipt of his query. This enables the user to choose a model or combination of models best suited to his needs.

In an embodiment, the method comprises a step of automatically updating at least one encoding layer of the digital portal. The update may involve updating encoding layer association scores, or query parameters, or updating layers and sublayers, for example to extend, reduce or hide them, or to display new layers or sublayers.

In an embodiment, the method comprises implementing a learning function to generate at least one encoding layer of the digital portal. The implementation of the learning function comprises, for example, the implementation of a neural network, for example a recurrent or convolutional neural network. The learning function is trained, for example, by a supervised method using labeled data, or by an unsupervised method using unlabeled data. The training data includes, for example, user data, such as data characterizing their opinion on the relevance of the models, or data characterizing a model's relative ranking, for example a number of downloads of each encoding model in relation to all downloads.

In an embodiment, implementation of the learning function comprises parameter and weight adjustment to minimize a difference between an actual output of the neural network and a target output.

In an embodiment, the implementation of the learning function comprises the implementation of an adaptive or e-learning function. This may be a neural network capable of dynamic learning in real time. Dynamic learning, for example, takes into account user interaction with the graphical interface, such as access to sub-categories, schemas or sequences of interactions, etc. Dynamic learning can, for example, adjust the encoding to hide or show certain content.

One advantage is to optimize access to results that are relevant to the user. Another advantage is that it gives administrators access to intelligent analysis of user data.

Another advantage is the dynamic optimization of the user experience.

System and program product: software and hardware resources According to another aspect, the inventive concepts relates to a system 100 comprising software and/or hardware means configured to implement the steps of the method of the inventive concepts.

The software and/or hardware means comprise at least one display E₁.

The software and/or hardware means comprise at least one memory MEM₁. The software and/or hardware means comprise at least one calculator CLC₁. The calculator CLC₁ is configured to generate commands for displaying a plurality of object lists on the display E₁.

The calculator CLC₁ is configured to implement automatic updates of at least one object list in response to at least one user command.

Optionally, the calculator CLC₁ is configured to implement a step of automatically updating at least one object in a list or sub-list using a generative learning algorithm, and in response to a user command.

The calculator CLC₁ is configured to generate search queries by means of query parameters P_{req} associated with at least a first object A₁ . . . Aₓ.

According to another aspect, the inventive concepts relates to a computer program product comprising instructions which, when the program is executed by a computer with which a user interacts, causes the system to implement any of the steps of the process according to the inventive concepts.

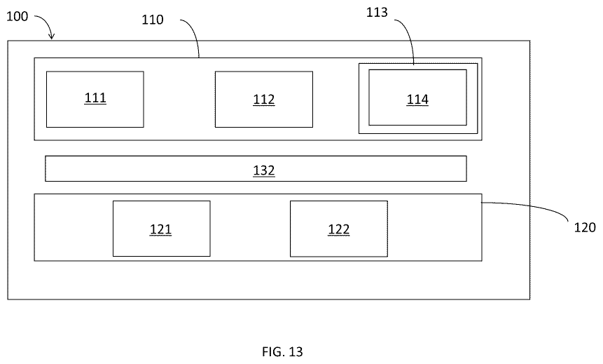

FIG. 13 is a diagram illustrating an example of the hardware configuration of system 100 according to the inventive concepts.

From a hardware point of view, system 100 can be seen as a computer interacting with a computer program product.

System 100 is a computer, for example, a microcomputer, a computer network, a tablet or a smartphone.

System 100 includes a calculation module 110. The calculation module comprises, for example, the calculator CLC₁. This calculation module 110 comprises, for example, one or more processors capable of interpreting instructions in the form of a computer program, a programmable logic circuit, such as an application-specific integrated circuit (ASIC), a field programmable gate array (FPGA), a programmable logic device (PLD) and programmable logic arrays (PLA), azsystem-on-a-chip (SOC), an electronic board in which process steps according to the inventive concepts are implemented in hardware elements. The processing can be carried out by one processor, or simultaneously or sequentially, or in some other way, by one or more processors.

The calculation module 110 comprises a data processing module 111 for performing calculations, a memory 112, operationally coupled to the data processing circuit 111, a computer-readable medium 114 and optionally a reader 113 adapted to read the computer-readable medium 114. The memory 112 comprises, for example, the memory MEM₁.

The 100 system also includes an input device, an output device and a communication device 132.

Each function of the system 100 is performed by causing the data processing module 111 to read a predetermined program from hardware such as memory 112 so that the data processing module 111 performs calculations, controls communications performed by the communication device 132 and to read and/or write data from memory 112 and the computer-readable medium 114.

The process is run on a single computer or on a distributed system between several computers (particularly via the use of cloud computing).

Memory 112 is a computer-readable storage medium, and can be configured with, for example, at least one of the following: read-only memory (ROM), erasable programmable read-only memory (EPROM), electrically erasable programmable read-only memory (EEPROM), random access memory (RAM) and other suitable storage media. The memory 112 can include an operating system and load programs according to the inventive concepts. It includes registers adapted to record parameter variables created and modified during execution of the aforementioned programs.

The program product may comprise the computer-readable recording medium 114 which is a tangible device, not being a transient signal per se, and may be configured with, for example, at least one of the following: a removable medium, such as, but not limited to, a magneto-optical disc (e.g. Compact Disc Read-Only Memory (CD-ROM)), a Digital Versatile Disc (DVD), a removable disk, a hard disk drive, a smart card, a flash memory device (e.g. card, key), a magnetic tape, a database, a server, and any other suitable storage medium.

Alternatively, the program instructions are taken from an external source and downloaded via a network. This is particularly the case for applications. In this case, the computer program product comprises a computer-readable data carrier on which the program instructions are stored, or a data carrier signal on which the program instructions are encoded.

The inventive concepts relates to a computer program product comprising the computer-readable medium 114 containing instructions which, when executed by the circuit 110 and interacting with a user, cause the system 100 to implement the steps of the process according to the inventive concepts.

The form of the program instructions is, for example, a source code form, a computer-executable form or any intermediate form between a source code and a computer-executable form, such as the form resulting from conversion of the source code via an interpreter, assembler, compiler, linker or localizer. Alternatively, the program instructions are microcode, firmware instructions, state definition data, IC configuration data (e.g. VHDL) or object code. The program instructions are written in any combination of one or more programming languages, e.g. an object-oriented programming language (C++, JAVA, Python), a procedural programming language (e.g. C language).

The system 100 also includes a user interface 120 comprising an input device 121 and an output device 122.

The user interface 120 comprises an input device 121 to enable the user to enter data or commands so as to be able to interact with the programs according to the inventive concepts. The input device 121 comprises, for example, a keyboard or a pointing interface, such as a mouse, an optical pen, a touchpad, a remote control, a voice recognition device, a haptic device, an eye movement tracking device, a body gesture detection device, and/or a brain-computer interface device.

The output device 122 is designed to output information to a user, either sensorially or electrically, such as visually or acoustically. The output interface 122 comprises, for example, a graphical user interface. The output interface 122 may be the input device, for example, in the case of a touch-sensitive tablet.

The set of at least one communication device 132 enables communication between elements of the system 100 and possibly between at least one element of the system and a device external to the system 100. This communication device 132 can establish a physical link between elements of the system 100 and/or between an element of the system 100 and a device external to the system 100 and/or a remote (wireless) communication link between elements of the system 100 and/or between an element of the system and a device external to the system 100.

The instant description is provided as an enabling teaching of the disclosure in its best, currently known aspect. Those skilled in the relevant art will recognize that many changes can be made to the aspects described, while still obtaining the functional results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

As used herein, the singular forms “a”, “an”, and “the” include plural referents unless the context clearly dictates otherwise. Thus, for example, reference to a “body” includes aspects having two or more bodies unless the context clearly indicates otherwise.

Ranges can be expressed herein as from “substantially” or “about” one particular value, and/or to “about” or “substantially” another particular value. When such a range is expressed, another aspect includes from the one particular value and/or to the other particular value.

Similarly, when values are expressed as approximations, by use of the antecedent “substantially” or “about,” it will be understood that the particular value forms another aspect. It will be further understood that the endpoints of each of the ranges are significant both in relation to the other endpoint, and independently of the other endpoint. As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure.

1-25. (canceled)

26. A method implemented on a computer for generating a query, the method comprising:
automatic encoding by a calculator of a plurality of lists of a plurality of first objects using user preference data, each encoded list symbolizing a category of query parameters distinct from other encoded lists, said encoding resulting in a first joint display on a display controlled by the calculator, of said plurality of lists of query parameters distinct from the other encoded lists of a plurality of first objects, the first objects of each list of first objects being positioned simultaneously on a first line of the display and each being operable by means of at least one first user command, each plurality of first objects of the respective lists being positioned on different respective first lines;
a first actuation of at least one first actuated object from among the first objects of a list of the plurality of lists by the first user command;
a first automatic updating, by the calculator and in response to the first actuation, of the first objects of at least one list taken from the plurality of lists and distinct from the list to which the actuated first object belongs, said automatic update resulting in the display of at least one new first object on the first line and distinct from the list to which the actuated first object belongs, said automatic update resulting in the display of at least one new first object on the first line on which are displayed the first objects of said list distinct from the list to which the actuated first object belongs; and
automatically generating, by the calculator in response to a second user command, of the query comprising query parameters associated with said new first object displayed and comprising query parameters associated with at least one second first object of at least one list taken from the plurality of lists.

27. The method according to claim 26, wherein the query is a software query selected from a search query to be submitted to a search engine, a generation query to be submitted to a generative artificial intelligence algorithm, a query to be submitted to a software application and/or a query to be submitted to an operating system.

28. The method of claim 26, further comprising: a step of displaying a list of second objects characterizing categories of user profiles positioned simultaneously on a same line distinct from the first line, said second objects each being independently actuatable by means of a user command, said actuation causing the calculator to automatically update at least one first object of at least one list taken from the plurality of lists.

29. The method of claim 26, wherein at least one first object of at least one list taken from the plurality of lists is operable by means of a user command to display a sub-list of Boolean operators displayed simultaneously with said first objects on the display and on a separate line, said Boolean operators being operable to combine and/or exclude parameters associated with at least two first objects on the display and on a separate line, said Boolean operators being operable to combine and/or exclude query parameters associated with at least two selected first objects.

30. The method of claim 26, wherein,
actuation of a first object by means of a user command results in extraction of data associated with said actuated first object, a computer being configured to process said extracted data to simultaneously update a set of lists actuated, the calculator being configured to process said extracted data to simultaneously update the set of lists displayed on the display, said updated lists being simultaneously displayed on the display,
at least one list of objects selected from lists of first objects, lists of second objects, lists of third objects, lists of fourth objects, and lists of fifth objects is masked in response to actuation of at least one first object, second object, third object, fourth object or fifth object from said object list or from a separate object list, and
an update of at least one first object, second object, third object, fourth object or fifth object of an object list results in automatic updating of at least one first object, second object, third object, fourth object or fifth object distinct from said updated object.

31. The method of claim 26, further comprising:
a second actuation, by a third user command, of at least one second actuated object taken from the first objects of a list of the plurality of lists distinct from the list to which the first actuated object belongs, said second actuation causing the calculator to extract values from digital entities stored in a memory, said digital entities each being associated with the second actuated object; and
a second displaying, on the display and controlled by the calculator in response to the third user command, of a sub-list of first objects on a second line coincident with, parallel to, or concentric with the first line on which the list to which the first actuated object belongs is displayed, the query parameters comprising the values of numerical entities associated with the second actuated object.

32. The method of claim 31, further comprising:
a first positioning, by a fourth user command of a first object to be positioned taken from among the first objects of one of the lists or the sub-list at an intersection between the first line on which the first object to be positioned is displayed and a reference line of a screen, query parameters being associated with each first object displayed at the intersection of one of the lines and the reference line, said first positioning causing an automatic update of all the lists of the plurality of lists.

33. The method of claim 26, further comprising:
automatically encoding lists of first objects, said encoding being implemented by the calculator using user preference data, each encoded list symbolizing a category of query parameters distinct from the other encoded lists, wherein,
the encoding further comprises implementing a learning function to dynamically update each list of first objects in real time, and
the automatic encoding of lists of first objects automatically results in said lists being displayed together on same page on the display.

34. The method of claim 26, wherein at least one first object, second object, third object, fourth object or fifth object of a list of objects is hidden in response to the actuation of at least one first object, second object, third object, fourth object or fifth object of said object list or of a separate object list.

35. The method of claim 26, wherein at least one of the first lines is a first circle.

36. The method of claim 32, further comprising:
a third positioning, by the fourth user command, of at least one third object to be positioned from among the first objects displayed on a first circle, inside a second circle concentric with the first circle and of radius of length smaller than the length of the radius of the first circle; and
a second automatic update, by the calculator, of the list of first objects positioned on the first circle in response to the third positioning, said update resulting in the display of at least one new first object on the first circle, a request being generated by means of request parameters associated with the third object to be positioned,
wherein the reference line passes through a center of the first circle.

37. The method of claim 26, further comprising:
a fourth displaying on the display, controlled by the calculator, of a list of second objects on a third line;
a third actuation of at least one third actuated object from among the second objects by means of the first user command; and
a third automatic update, by the calculator, of a set of lists of first objects, said update resulting in the display of new first objects on the first lines.

38. The method of claim 26, further comprising:
a step of a third displaying, on the display, controlled by the calculator, of at least a third object associated with values of digital entities stored in a memory, said values of digital entities comprising timestamp parameters, the query parameters comprising the timestamp parameters associated with digital entity values stored in a memory, said digital entity values comprising timestamp parameters, the query parameters comprising the timestamp parameters of said digital entity values associated with the third object.

39. The method of claim 26, wherein the first command comprises a second user command and/or comprises a third user command and/or comprises a fourth user command.

40. The method of claim 26, further comprising:
displaying a plurality of fourth objects symbolizing widgets operable by a user and displayed simultaneously with the plurality of lists of first objects.

41. The method of claim 26, further comprising:
displaying a plurality of fifth objects simultaneously with the plurality of lists of first objects and able to receive a plurality of data extracted in response to the actuation of a first object and/or a second object and/or a third object and/or a fourth object.

42. A query generation system, comprising:
a plurality of computer readable instructions when executed by a processor, configure the processor to,
automatically encode, by means of a calculator, a plurality of lists of a plurality of first objects using user preference data, each encoded list symbolizing a category of query parameters distinct from other encoded lists, said encoding resulting in a joint first display on the display, by means of a command from the calculator, said encoding resulting in a joint first display on the display, by a control of a computer, of said plurality of lists of first objects, the first objects of each list being positioned on a first line of the display, the first objects of the respective lists being positioned on different respective first lines,
automatically update, by means of the calculator and in response to a first user command, the first objects of at least one list taken from the plurality of lists and distinct from the list to which a first actuated object belongs, said automatic updating resulting in the display of at least one new first object on the first line on which are displayed the first objects of said list distinct from the list to which the first actuated object belongs, and
automatically generate the query by means of the calculator and in response to a second user command, said query comprising query parameters associated with said new first displayed object and comprising query parameters associated with at least one second first object of at least one list taken from the plurality of lists.

43. The system of claim 42, further comprising: a display and a memory.

44. A computer program product comprising:
a memory comprising computer readable instructions stored thereon, and
at least one processor configured to execute the computer readable instructions to,
automatically encode, by means of a calculator, a plurality of lists of a plurality of first objects using user preference data, each encoded list symbolizing a category of query parameters distinct from other encoded lists, said encoding resulting in a joint first display on the display, by means of a command from the calculator, said encoding resulting in a joint first display on the display, by a control of the computer, of said plurality of lists of first objects, the first objects of each list being positioned on a first line of the display, the first objects of the respective lists being positioned on different respective first lines;
automatically update, by means of the calculator and in response to a first user command, the first objects of at least one list taken from the plurality of lists and distinct from the list to which a first actuated object belongs, said automatic updating resulting in the display of at least one new first object on the first line on which are displayed the first objects of said list distinct from the list to which the first actuated object belongs; and
automatically generating the query by means of the calculator and in response to a second user command, said query comprising query parameters associated with said new first displayed object and comprising query parameters associated with at least one second first object of at least one list taken from the plurality of lists.

45. A non-transitory computer-readable recording medium comprising computer readable instructions stored thereon, that when executed by a processor configure the processor to:
automatically encode, by means of a calculator, a plurality of lists of a plurality of first objects using user preference data, each encoded list symbolizing a category of query parameters distinct from other encoded lists, said encoding resulting in a joint first display on the display, by means of a command from the calculator, said encoding resulting in a joint first display on the display, by a control of the computer, of said plurality of lists of first objects, the first objects of each list being positioned on a first line of the display, the first objects of the respective lists being positioned on different respective first lines;
automatically update, by means of the calculator and in response to a first user command, the first objects of at least one list taken from the plurality of lists and distinct from the list to which first actuated object belongs, said automatic updating resulting in the display of at least one new first object on the first line on which are displayed the first objects of said list distinct from the list to which the first actuated object belongs; and
automatically generating the query by means of the calculator and in response to a second user command, said query comprising query parameters associated with said new first displayed object and comprising query parameters associated with at least one second first object of at least one list taken from the plurality of lists.
